(19) United States
(12) Patent Application Publication
(10) Pub. No.: US 2012/0078903 A1
(43) Pub. Date: Mar. 29, 2012

(54) IDENTIFYING CORRELATED OPERATION MANAGEMENT EVENTS

(76) Inventors: Stefan Bergstein, Ehningen (DE); Chetan Kumar Gupta, Austin, TX (US); Abhay Mehta, Austin, TX (US); Song Wang, Austin, TX (US)

(21) Appl. No.: 12/888,800

(22) Filed: Sep. 23, 2010

(51) Int. Cl. G06F 17/30

(52) U.S. Cl. 707/737; 707/E17.089

(57) ABSTRACT

A technique includes receiving data indicative of operation management events, where each event occurs at an associated time. The technique includes processing the data to selectively group the events in episodes based on the associated times and identifying which events are correlated based at least in part on the episodes.

### TECHNICAL FIELD OF THE INVENTION

The invention generally relates to identifying correlated operation management events.

### BACKGROUND

An information technology (IT) business service typically includes applications, middleware, systems and a storage infrastructure that are all closely connected. A given problem occurring in one of these domains may result in problems in other of the domains, leading to the logging of multiple operation management events. Multiple teams typically coordinate actions to gather cross domain knowledge and perform a root cause analysis to solve related inter-domain problems.

### BRIEF DESCRIPTION OF THE DRAWING

FIG. 1 is a schematic diagram of a processing system according to an example implementation.

FIG. 2 is a flow diagram depicting a technique to determine correlation rules for operation management events according to an example implementation.

FIG. 3 is a flow diagram depicting a technique to determine episodes according to an example implementation.

FIG. 4 is an exemplary snapshot of a graphical representation of identified correlation rules according to an example implementation.

### DETAILED DESCRIPTION

Problems occurring in multiple domains of a given computer system may be logged as operation management events in an operation management event log, which contains time-stamped event descriptions that correspond to inter-domain problems. Some of the operation management events may be related and as such, arise from the same root cause. Other events are not related and occur due to independently occurring problems. Due to at least the volume of logged operation management events, sorting through the logged events and attempting to find out which events are correlated may be a formidable task, especially if performed manually. Systems and techniques are disclosed herein, which automatically process logged operation management events to identify events that are related, or correlated, to each other for purposes of developing correlation rules that set forth relationships between events. For example, a particular correlation rule may be that when event A happens, events B and C occur. Such rules facilitate the recognition of specific problems and the development of and application of solutions to these problems.

As an example, in some implementations, it is generally assumed that operation management events that are correlated occur in the vicinity of each other in terms of time. In particular, as an example, correlation rules may be determined pursuant to a technique that includes grouping the event into episodes based on how close the events are together in time and then identifying the correlated events of each episode.

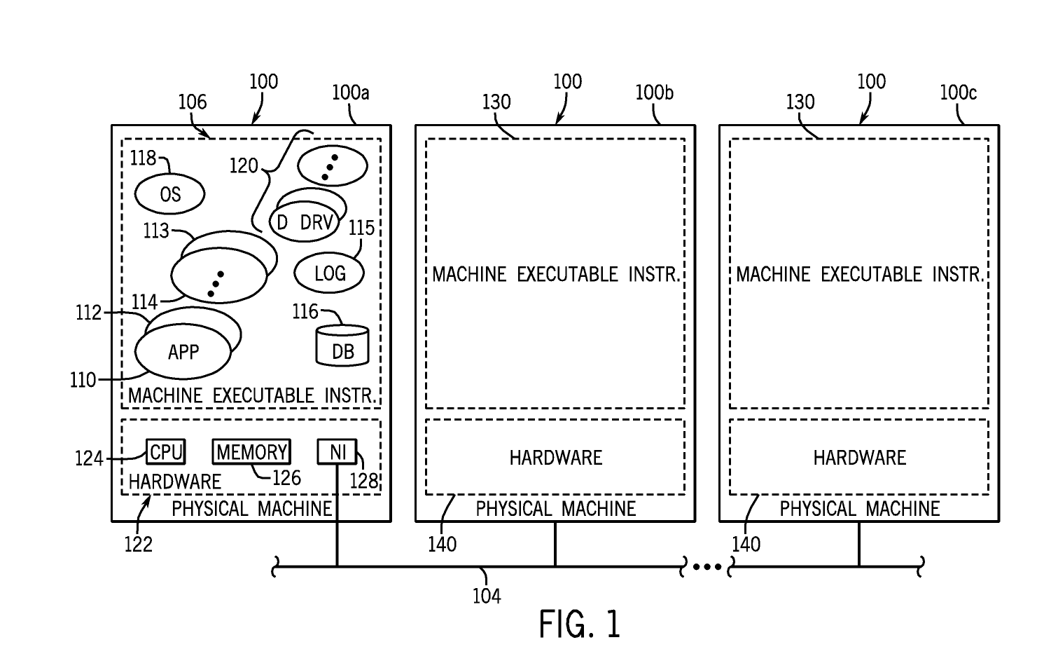

Referring to FIG. 1, as a non-limiting example, the systems and techniques that are disclosed herein may be implemented on an architecture that includes one or multiple physical machines 100 (physical machines 100a and 100b, being depicted in FIG. 1, as examples). In this context, a “physical machine” indicates that the machine is an actual machine made up of executable program instructions and hardware. Examples of physical machines include computers (e.g., application servers, storage servers, web servers, etc.), communications modules (e.g., switches, routers, etc.) and other types of machines. The physical machines may be located within one cabinet (or rack); or alternatively, the physical machines may be located in multiple cabinets (or racks).

As shown in FIG. 1, the physical machines 100 may be interconnected by a network 104. Examples of the network 104 include a local area network (LAN), a wide area network (WAN), the Internet, or any other type of communications link. The network 104 may also include system buses or other fast interconnects.

In accordance with a specific example described herein, one of the physical machines 100a contains machine executable program instructions and hardware that executes these instructions for purposes of automatically identifying, or determining, event correlation rules based on logged operation management events, such as events that are logged in an exemplary operation management event log 115 that is depicted in FIG. 1. As an example, each operation management event may be logged in the operation management log 115 in the form of data indicative of a time that the event occurred (i.e., a timestamp) as well as data indicative of a description of the event.

The processing by the physical machine 100a results in data indicative of correlation rules that identify whether, for example, a particular event A is correlated to event B. Whether event A is deemed to be correlated to event B is regulated by such measures as support and confidence. The support measure specifies how often the rule occurs (i.e., |AUB|) for a correlation to occur, and the confidence measures a minimum for the probability of P(B|A), meaning that the confidence measure specifies what percentage of times did event B happen, given event A. Genuine correlations may be identified by setting thresholds corresponding to the support and confidence measures particularly high.

Therefore, by identifying the correlation rules, a correlation rule database 116 may be updated and maintained (such as in local, external storage or on remote storage) for purposes of quickly finding the root causes of present and future inter-domain problems that are indicated by the time-stamped event descriptions that are stored in the operation management log 115.

It is noted that in other implementations, all or part of the above-described correlation rule identification may be implemented on one, two, three or more physical machines 100. Therefore, many variations are contemplated and are within the scope of the appended claims.

The architecture that is depicted in FIG. 1 may be implemented in an application server, a storage server farm (or storage area network), a web server farm, a switch or router farm, other type of data center, and so forth. Additionally, although each of the physical machines 100 is depicted in FIG. 1 as being contained within a box, it is noted that a physical machine 100 may be a distributed machine having multiple nodes, which provide a distributed and parallel processing system.

As depicted in FIG. 1, in some implementations the physical machine 100a may store machine executable instructions 106. These instructions 106 may include one or multiple applications (described below), an operating system 118 and one or multiple device drivers 120 (which may be part of the operating system 118). In general, the machine executable instructions are stored in storage, such as (as non-limiting examples) in a memory (such as a memory 126) of the physical machine 100a, in removable storage media, in optical storage, in magnetic storage, in non-removable storage media, in storage separate (local or remote) from the physical machine 100a, etc., depending on the particular implementation.

In general, the physical machine 100a, for this example, includes a set of machine executable instructions, which when executed by the CPU(s) 124 form an “event pre-processing application 110”, which is responsible for mapping the operation management events contained in the log 115 to a set of surrogate event types, which are further processed to group the events into episodes. In this manner, the physical machine 100a also includes a set of machine executable instructions, which when executed by the CPU(s) 124 form an episode creator, or “episode creation application 112,” which is responsible for processing the surrogate event types to organize the events into episodes. In general, a given episode contains events that occur within a certain time interval (called “t”) of each other. Additionally, the physical machine 100a, for this example, includes a set of machine executable instructions, which when executed by the CPU(s) 124 form a “data mining application 114,” which is responsible for processing each episode to identify correlation rules (if any) within the episode. The functionality of the applications 110, 112 and 114 may be consolidated into a single application or into two applications; or the functionality of the applications 110, 112 and 114 may be performed by more than three applications, as many implementations are contemplated and are within the scope of the appended claims.

In general, the other physical machines of FIG. 1, such as physical machines 100b and 100c, contain machine executable instructions 130 and hardware 140. In general, these instructions 130 and hardware 140 form middleware, systems and storage infrastructure that may be relatively closely connected and may generate interconnected inter-domain events. In this manner, a particular failure in one of these components may generate a series of operations management event entries, which are communicated to the physical machine 100a and stored in the operation management event log 115. In other implementations, more than one physical machine 100 may store its own version of an operation management event log; and the “operation management event log” that is processed for purposes of identifying correlation rules may be a log collectively formed from all of the logs stored on the machines 100. It is assumed as a non-limiting example for the following discussion that the operation management event log 115 contains all of the inter-domain event entries for the entire system.

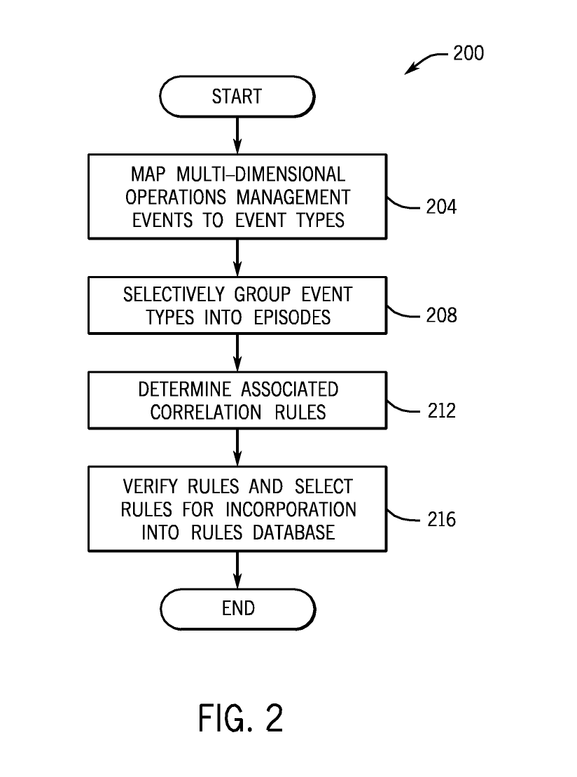

As a more specific example, in accordance with some embodiments of the invention, the physical machine 100a performs a technique 200 that is depicted in FIG. 2 for purposes of processing the operation management event log 115 to identify, or determine, correlation rules. Referring to FIG. 2 in conjunction with FIG. 1, in particular, the technique 200 includes the event pre-processing application 110 mapping (block 204) logged multi-dimensional operation management events to surrogate event types. Next, according to the technique 200, the episode creation application 112 selectively groups (block 208) event types into episodes. Each episode is effectively a group of events that occur within time t of each other. The episodes are processed by the data mining application 114 for purposes of determining (block 212) associated correlation rules. It is noted that the rules may be manually or automatically verified (block 216) for purposes of selecting a subset of these rules for incorporation into a rules database, such as the rules database 116.

Referring to FIG. 1, the event pre-processing application 110 processes the time-stamped event descriptions that are contained in the event log 115 to generate corresponding surrogate event types. In accordance with some implementations, the surrogate event types are plain integer numbers, which, along with associated time stamps, are further processed by the episode creation application 112.

In accordance with an example, the event pre-processing application 110 determines the surrogate event type for a given event description by decomposing the event description and comparing this decomposed event description with one or more decomposed event descriptions. More specifically, in general, the event description, which may take on numerous forms, may contain a fixed part as well as one or more variable parts. For example, a exemplary generic event description for a logging error may be as follows:

DBSPI10-82: Data logging failed for <Object Name>. Make sure Performance Agent is running.

In the above example, the values in the angle brackets are variables, and the other text is fixed. As a more specific example, the following are two specific event description instances:

DBSPI10-82: Data logging failed for DBSPI_MSS_GRAPH. Make sure Performance Agent is installed and running.
BlackBerry Dispatcher WBCXOEB021 [0×2710] 8304: (#50099) BlackBerry Dispatcher Shutdown complete

In accordance with an example implementation, for purposes of classifying an event as a particular surrogate event type, the event pre-processing application 110 subdivides the event description into words, or tokens; discards single character tokens; and thereafter performs other measures to determine whether a given event description is the same or nearly the same as another event description.

For example, in accordance with an exemplary implementation, the event pre-processing application 110 may evaluate a given event description to determine if the given event description corresponds to a certain predetermined surrogate event classified in the following manner. For this example, the event pre-processing application 110 compares the given event description to a reference event description, which is associated with the predetermined surrogate event classifier. This comparison may involve determining whether at least two of the tokens are at the same position and if so, whether at least two thirds of the tokens at the same positions are identical. If the given event description passes these comparison measures, then the event pre-processing application 110 assigns the predetermined surrogate event classifier to the given event description. Otherwise, the event pre-processing application 110 searches for another appropriate surrogate event classifier and may (if all comparisons fail) assign a new surrogate event classifier. Other token similarity measures may be used, in accordance with other exemplary implementations. Moreover, in accordance with some implementations, the event pre-processing application 110 examines a first predetermined number (fifteen, for example) of tokens of each event description for purposes of increasing processing speed.

As another example of a measure used to process the event description, in accordance with some implementations, the event pre-processing application 110 uses an additional vector, or field, of the event description, which identifies a particular application type. In this manner, the event pre-processing application 110 presumes that all event descriptions that are associated with the same surrogate event type are also associated with the same type of application. Therefore, by excluding non-similar application attributes, the event pre-processing application 110 avoids comparing all event descriptions that are contained in the operation management log 115.

As a non-limiting example, one way for the episode creation application 112 to organize the surrogate event types into episodes is based on the timestamps of the surrogate event types. This is based on the observation if event A is correlated to event B, then there is an expectation that the two events A and B occur within a time t of each other. Therefore, for purposes of creating episodes, in accordance with some implementations, the episode creation application 112 groups events that occur within time t of each other together. In other words, the episode creation application 112 receives a dataset (called “D”) from the event pre-processing application 110, which indicates a set of surrogate event types and the associated timestamps of these surrogate event types; and the episode creation application 110 maps the D dataset to another dataset of episodes (called “D′”). Each episode has an associated episode identification (ID), and, in general, is a set of events, which occurred within some time t of each other.

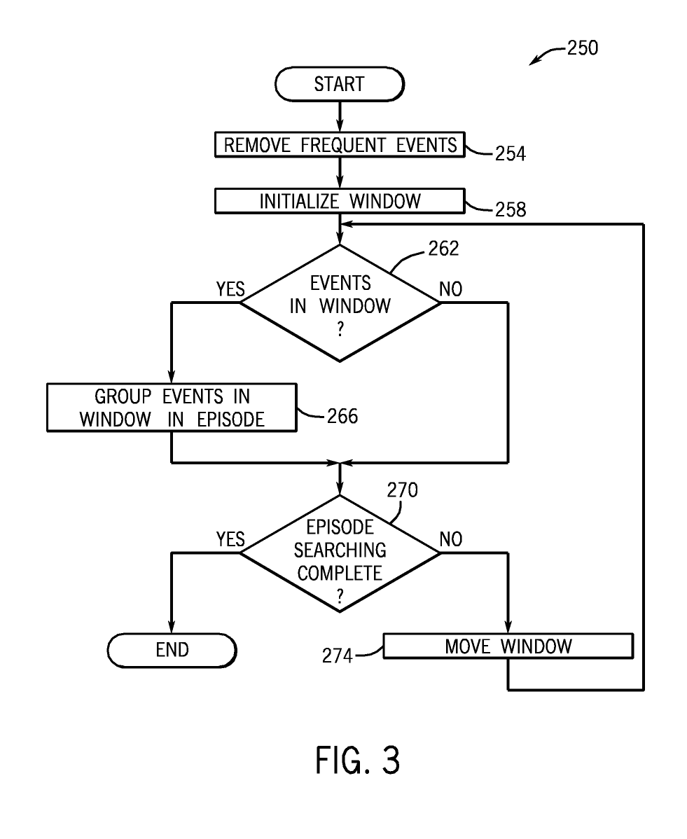

In accordance with some implementations, the creation of the episodes may be performed in a manner that is depicted in a technique 250 of FIG. 3. Referring to FIG. 3 in conjunction with FIG. 1, pursuant to the technique 250, the episode creation application 112 first removes (block 254) the event types that occur relatively frequently. As an example, the episode creation application 112 may compare the rate, or frequency, at which an event type occurs to a programmable threshold and remove the event type if the threshold is exceeded. The reason for the removal of frequent event types is that the more popular the event, the higher the probability that the event will occur with other events because of random chance. Otherwise including the frequent event types increases the number of identified correlation rules that may not be helpful to the operations administrator and thus, may increase the time and cost associated with sorting the correlation rules that are provided by the data mining application 114.

After the frequent event types have been removed, pursuant to block 254, the technique 250 includes initializing (block 258) a window of time. In this regard, the time at which the events occur span a certain range of time, and the episode creation application 112 slides the time window across this range to identify events (that fall within the confines of the window) to be grouped in the same episode.

More specifically, if the entire time range is divided into time intervals of size t+Δ and the window is moved by Δ until the entire time range is covered. Then for Δ=t/2, any event i that occurs at Tᵢ, there exists an episode E such that all events occur within Tᵢ−t/2 and Tᵢ+t/2 and are contained in episode E. The choice of Δ is a tradeoff, where a relatively small Δ results in a large number of positions for the sliding window making the computation prohibitively expensive; and a relatively large Δ introduces a larger inaccuracy, because only those events that occur in the time range of interest are considered along with events that are part of other episodes. In accordance with some implementations, the assumption is made that the cost of introducing inaccuracy is the same as that of the computational cost, which means that Δ is set equal to time t. Thus, in accordance with an example implementation, the sliding window has a size of 2t and is moved by time t for each episode identification.

Thus, still referring to FIG. 3, for the current position of the sliding window, if events are in the window (diamond 262), then the events are grouped (block 266) in an episode. If the episode creation application 112 determines (diamond 270) that the episode searching is complete, then the technique 250 terminates. Otherwise, the episode creation application 112 moves (block 274) the sliding window (such as moving the sliding window by the time t, as described in the example above), and control returns to diamond 262.

After the episode creation application 112 identifies the episodes and generates the corresponding D′ dataset, the episodes are processed by the data mining application 114, which identifies whether given events are correlated based at least in part on an examination of all of the episodes to determine whether the given events occur together across a significant number of episodes. In general, the generation of correlation rules (whether event A is correlated to event B, for example) are governed by thresholds that are supplied as input parameters to the application 112, which specifies support and confidence. The support measures how often the rule occurs, and the confidence measures the probability of event B occurring given event A. In general, the thresholds are set so that the data mining application 114 obtains rules with relatively high confidence and relatively high support.

As a non-limiting example, the data mining application 114 may be the Enterprise Miner's application, which is available from SAS. The data mining processes the D′ episode dataset that is provided by the episode creation application 112 to generate a set of rules and a link graph showing how various rules are related to each other. Furthermore, the application 114, in accordance with some implementations, provides a visual presentation of the confidence and support.

Referring back to FIG. 1, in accordance with some implementations, the machine executable instructions 106 contain a set of machine executable instructions (called “the verification application 113” herein), which examines the rules provided by the data mining application 112 for purposes of selecting rules for incorporation into the rules database 116. At least one way to select rules for incorporation into the rules database 116 is disclosed in copending application entitled, “METHOD AND SYSTEM FOR EVENT CORRELATION,” (HP Disclosure No. 201001506), which is being filed concurrently herewith. In other implementations, the selection of the rules for the rules database 116 may be performed manually. Thus, many variations are contemplated and are within the scope of the appended claims.

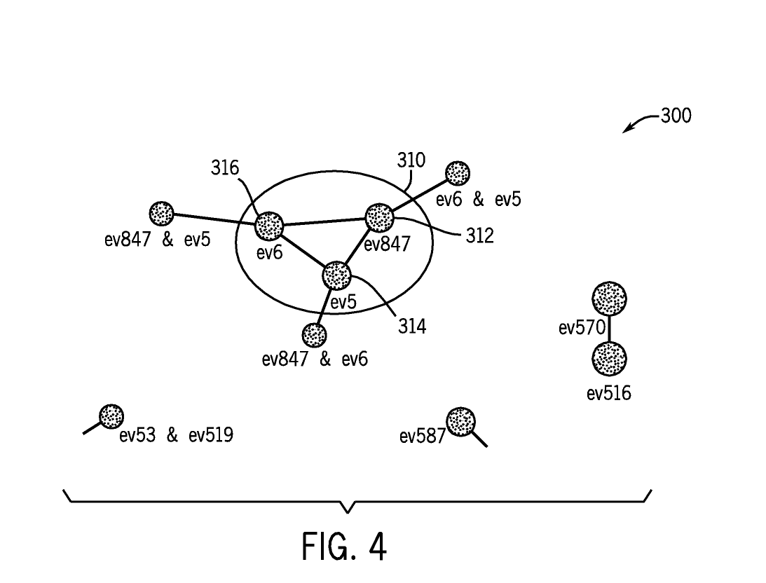

FIG. 4 depicts an exemplary snapshot 300 of a graphical representation of correlation rules identified by the data mining application 114. Events indicated by a circle 310 (i.e., events 312, 314 and 316) illustrate a situation where three correlated event types that correspond to a common problem were determined by the data mining application 114:

847 Configuration distribution pending: Template . . .
5 Can't read template file . . .
6 Distribution problem occurred . . .

These events may otherwise be identified as distinct and independent events that are scattered among other events. Therefore, the systems and techniques that are disclosed herein provide guidance for creating event correlation rules according to newly found association rules.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
receiving data indicative of operation management events, each event occurring at an associated time;
processing the data in a machine to selectively group the events in episodes based on the associated times; and
identifying which events are correlated based at least in part on the episodes.

2. The method of claim 1, further comprising:
classifying the events according to event types, comprising for each event, subdividing a description of the event into tokens and classifying the event based on a comparison of the tokens with tokens derived from the other event descriptions.

3. The method of claim 1, wherein the identifying comprises determining whether given events are correlated based on an examination of all of the episodes to determine whether the given events occur together across a significant number of the episodes.

4. The method of claim 1, wherein the processing the data to selectively group the events comprises selectively grouping the events based on events that occur within a predetermined duration of time of each other.

5. The method of claim 1, wherein the processing the data to selectively group the events further comprises selectively removing events from the grouping based on a frequency at which the event occurs.

6. The method of claim 1, further comprising:
determining correlation rules for correlated events.

7. An article comprising a computer readable storage medium to store instructions that when executed by a computer cause the computer to:
receive data indicative of events occurring in a system, each event occurring at an associated time;
process the data to selectively organize the events in episodes based on the associated times; and
submit each of the episodes to a data miner to identify whether any correlation rules are associated with the episode.

8. The article of claim 7, the storage medium storing instructions that when executed by the computer cause the computer to selectively organize the events in the episodes such that events that occur within a predetermined time of each other are grouped in the same episode.

9. The article of claim 8, wherein the associated times span a time range, the storage medium storing instructions that when executed by the computer cause the computer to slide a window of time over the range and select events having associated times that fall within time boundaries indicated by the window for inclusion in the same episode.

10. The method of claim 1, the storage medium storing instructions that when executed by the computer cause the computer to selectively remove events from being considered for inclusion in one of the episodes based on a frequency at which the event occurs.

11. The method of claim 1 the storage medium storing instructions that when executed by the computer cause the computer to classify the events according to event types and process the event types to organize the events into the episodes.

12. The method of claim 11, the storage medium storing instructions that when executed by the computer cause the computer to, for each event, subdivide a description of the event into tokens and classify the event based on a comparison of the tokens with tokens derived from at least one of the other events.

13. The method of claim 11, the storage medium storing instructions that when executed by the computer cause the computer to determine the event type based at least in part on an affiliated application.

14. An apparatus comprising:
a log to store data indicative of operation management events, each event occurring at an associated time; and
a processor-based episode creator to selectively group the events in episodes based on the associated times and for each episode, communicate data indicative of the episode to a data miner to determine whether events of the episode are correlated.

15. The apparatus of claim 14, wherein the episode creator selectively groups the events based on events that occur within a predetermined duration of time of each other.

16. The apparatus of claim 14, wherein the episode creator selectively removing events from the grouping based on a frequency at which the event occurs.

17. The apparatus of claim 14, wherein the episode creator classifies the events according to event types.

18. The apparatus of claim 14, wherein the episode creator, for each event, subdivides the events into tokens, and classifies the event based on a comparison of the tokens with tokens derived from the other events.

19. The apparatus of claim 14, wherein the episode creator communicates data to the data miner indicative of a support threshold specifying how often events are to occur before the events are otherwise considered to be correlated.

20. The apparatus of claim 14, wherein the episode creator communicates data to the data miner indicative of a confidence threshold specifying a conditional probability for two events before the events are otherwise considered to be correlated.
